(19) United States
(12) Patent Application Publication
(10) Pub. No.: US 2026/0310788 A1
(43) Pub. Date: Oct. 8, 2026

(54) Monitoring A Control Program Of At Least One Functional Unit Of A Machine Installation

(71) Applicant: Siemens Aktiengesellschaft, München (DE)

(72) Inventors: Stefan Becker, Adelsdorf (DE); Rainer Falk, Erding (DE); Christian Peter Feist, Grafrath (DE); Henning Janssen, Jockgrim (DE)

(73) Assignee: Siemens Aktiengesellschaft, München (DE)

(21) Appl. No.: 19/106,393

(22) PCT Filed: Aug. 22, 2023
(86) PCT No.: PCT/EP2023/073008

§ 371 Date: Feb. 25, 2025

(30) Foreign Application Priority Data
Aug. 30, 2022 (EP) 22192881.5

(51) Int. Cl. G06F 21/57; G06F 11/07

(52) U.S. Cl. CPC G06F 21/57; G06F 11/0793

(57) ABSTRACT

Various embodiments include a method for monitoring a control program of a functional unit of a machine installation using an electronic computing device. An example includes: detecting a vulnerability within the control program; categorizing the detected vulnerability on the basis of vulnerabilities already analyzed in the past; and proposing a corrective action for the vulnerability depending on the categorization.

### CROSS-REFERENCE TO RELATED APPLICATIONS

This application is a U.S. National Stage Application of International Application No. PCT/EP2023/073008 filed Aug. 22, 2023, which designates the United States of America, and claims priority to EP Application No. 22192881.5 filed Aug. 30, 2022, the contents of which are hereby incorporated by reference in their entirety.

### TECHNICAL FIELD

The present disclosure relates to machine installations. Various embodiments of the teachings herein include methods for monitoring a control program of at least one functional unit of a machine installation by means of an electronic computing device.

### BACKGROUND

It is already known that, for example, the relevant software or control programs or so-called firmware in machine installations in production chains may contain vulnerabilities. Therefore, it is important that the software or firmware can be updated. This involves installing a patch or a new version of the software or firmware. The client currently has the problem that they currently have to process any changes individually. The vulnerabilities can be categorized as follows. For example, a vulnerability can be categorized as open or corrected. It can also be ascertained whether the software or firmware is not affected by the particular vulnerability. Accordingly, it is currently manually assessed which category the vulnerability belongs to and an appropriate assignment is made.

It is also known that information on vulnerabilities is provided in a structured manner so that they can be automatically captured and processed. This is known by the term CVE (common vulnerabilities and exposures). A vulnerability is identified by a unique identifier, the affected hardware or software components are specified and the severity is assessed by a CVSS score (common vulnerabilities scoring system). Information on vulnerabilities is provided via appropriate CVE databases. A so-called SCAP (Security Content Automation Protocol) is used to define data formats in order to automate security management.

### SUMMARY

The teachings of the present disclosure provide methods, computer program products, computer-readable storage media and electronic computing devices, which simplify the monitoring of a control program. For example, some embodiments of the teachings herein include a method for monitoring a control program (12) of at least one functional unit (14) of a machine installation (16) by means of an electronic computing device (10), comprising: detecting a vulnerability (18) within the control program (12) ; (S1) categorizing the detected vulnerability (18) on the basis of vulnerabilities already analyzed in the past; (S2.1, S2.2, S2.3) and proposing a corrective action for the vulnerability (18) depending on the categorization. (S3)

In some embodiments, the vulnerability (18) is categorized into at least two categories, in particular at least three categories.

In some embodiments, a first category identifies the vulnerability (18) as open (S2.1), a second category identifies the vulnerability (18) as closed (S2.2) and a third category identifies the vulnerability (18) as not relevant to the functional unit (14) (S2.3).

In some embodiments, the categorization is carried out on the basis of a vulnerability characteristic of the vulnerability (18).

In some embodiments, a type and/or a manufacturer of the relevant functional unit (14) and/or a location of the relevant functional unit (14) is described by means of the vulnerability characteristic.

In some embodiments, an update of the control program (12) is proposed as the corrective action.

In some embodiments, within the categorization, the vulnerability (18) is compared with other vulnerabilities and, if the vulnerability (18) is similar to at least one other closed vulnerability, the corrective action of the further, already closed, vulnerability is proposed for the vulnerability (18).

In some embodiments, the detection of the vulnerability (18) and/or the categorization of the vulnerability (18) and/or the proposal of the corrective action is/are carried out by means of a machine learning algorithm of the electronic computing device (10).

In some embodiments, the categorized vulnerability (18) is analyzed and taken into account for the detection and/or categorization and/or correction of a future vulnerability.

In some embodiments, an effect of the correction for the vulnerability (18) on another detected vulnerability is investigated.

In some embodiments, the electronic computing device (10) is provided as a central electronic computing device (10) external to the machine.

In some embodiments, the implementation of the corrective action is carried out automatically using the electronic computing device (10).

As another example, some embodiments include a computer program product having program code means, which cause an electronic computing device (10) to carry out one or more of the methods described herein.

As another example, some embodiments include a machine-readable storage medium having at least one computer program as described herein.

As another example, some embodiments include an ultrasonic computing device (10) for monitoring a control program (12) of at least one functional unit (14) of a machine installation (16), wherein the electronic computing device (10) is designed to carry out one or more of the methods as described herein.

### BRIEF DESCRIPTION OF THE DRAWINGS

The teachings of the present disclosure is now described in further detail by reference to exemplary embodiments shown in the drawings. In the drawings:

FIG. 1 shows a schematic flowchart of an example method incorporating teachings of the present disclosure; and

FIG. 2 shows a schematic block diagram of an example electronic computing device incorporating teachings of the present disclosure.

### DETAILED DESCRIPTION

Some embodiments of the teachings herein include a method for monitoring a control program of at least one functional unit of a machine installation by means of an electronic computing device. A vulnerability is detected within the control program. The detected vulnerability is categorized on the basis of vulnerabilities that have already been analyzed in the past. A corrective action is then proposed for the vulnerability depending on the categorization.

Some embodiments include automated categorization or grouping of reported vulnerabilities and the measures derived from them in a specific environment. For this purpose, an analysis of the vulnerability reports is carried out, from which actions are derived in the specific case. Within this analysis, for example, a vulnerability is assessed as to whether it is open, corrected, or whether this control program is not affected by the vulnerability.

In some embodiments, a software-assisted automatic assignment of the vulnerability then takes place into one of the categories listed or mentioned, in which, for example, similar vulnerabilities have previously been categorized.

In some embodiments, a search function for similar vulnerabilities and their handling has the advantage that it substantially saves manual effort for searching and handling and significantly increases the user-friendliness. The search, which is designed to be as specific as possible, can thereby meaningfully enhance the search selection and indicate it to the client or provider for all suitable solution options, for example to find and deploy the appropriate patch for their vulnerability.

It should be noted here that the term “patch” is to be understood in a broad sense. This is generally used to refer to an update of a software and/or firmware or of the control program. In particular, it can take the form of an update for industrial IoT (Internet of Things) devices or a control unit. It can also be an update for a virtual automation function or a virtual control unit of the IoT devices.

In some embodiments, a complete update and thus shutdown of the machine is prevented by carrying out a corresponding corrective action which does not bring the machine to a standstill. The machine itself comprises the at least one functional unit, in particular a plurality of functional units. A functional unit can then be assigned in turn to a plurality of control programs.

Thus, the teachings of the present disclosure may prevent a shutdown of the machine on the basis of simple checking of the control programs and corresponding recommendations for action or corrective actions, whereby, in particular in the case of series processing installations, a prolonged failure can be prevented, thus saving large-scale effort and expenditure.

In some embodiments, the vulnerability is categorized into at least two, in particular at least three, categories. In particular, a first category will identify the vulnerability as open, a second category will identify the vulnerability as closed, and a third category will identify the vulnerability as not relevant to the functional unit. This means that a categorization can be carried out in a simple manner which describes the vulnerabilities accordingly and then appropriate corrective actions can be proposed, for example in the case of purely open vulnerabilities.

In some embodiments, the categorization is carried out on the basis of a characteristic of the vulnerability. In particular, the similarity of the vulnerabilities is defined in such a way that a specific “policy” is defined for the vulnerability characteristic. It may be provided, for example, that a type and/or a manufacturer of the relevant functional unit and/or a location of the relevant functional unit are described by means of the vulnerability characteristic. For example, the type and manufacturer of the affected component or functional unit, the location, in particular physically and/or topologically, of the affected functional unit, the type of vulnerability, for example, a remote code execution, buffer overflow, denial of service, availability of an update or workaround can be defined for this purpose, whereby a corresponding search request can begin, which reviews the previous vulnerability assessment for the specified parameters, compares it and issues a classification proposal or categorization based on the matching criteria.

In some embodiments, an update of the control program is proposed as a corrective action. In particular, the categorization or grouping is the basis for the further procedure, for example the definition and implementation of a suitable corrective measure for this vulnerability by means of a corresponding patch. It may also be found that the vulnerability has already been corrected or is not considered critical or not relevant. Further countermeasures may also be taken, such as disconnecting a subnet, blocking a port by a firewall, stopping a machine, shutting down an automation system or the like.

In some embodiments, within the categorization, the vulnerability is compared with other vulnerabilities and, if the vulnerability is similar to at least one other closed vulnerability, the corrective action of the further, already closed, vulnerability is proposed for the vulnerability. In other words, the systematics of the specific policy can also be supplemented by a comparison of the aforementioned action measures, which can mean they are reused in a similar case or vulnerability. For this purpose, for example, the electronic computing device is provided as a machine learning algorithm and is trained to learn which actions were performed by a security administrator in the event of a specific vulnerability report. These actions are recorded as a template or as an example. In the case of a similar vulnerability report, one or more templates can then be automatically proposed. The recommendation for action can indicate what needs to be done and also, under which boundary conditions of the technical system or automation component these measures will be implemented.

In some embodiments, the detection of the vulnerability and/or the categorization of the vulnerability and/or the proposal of the corrective actions is/are carried out by means of a machine learning algorithm of the electronic computing device. For example, the machine learning algorithm can be provided as an artificial intelligence system, for example in the form of a neural network. In particular, the detection, categorization and/or proposal for corrective actions can therefore be simplified and implemented rapidly in the future. Furthermore, it can also be provided that, for example, the correction itself is carried out automatically by means of the neural network.

In some embodiments, it may be advantageous to analyze the categorized vulnerability and take it into account for detection and/or categorization and/or correction of a future vulnerability. Thus, the electronic computing device can learn and in future use not yet categorized vulnerabilities in order to use them for future vulnerabilities. Thus, it is a system capable of learning, which can be checked in a simple manner.

In some embodiments, it may be advantageous to investigate the effect of the correction of the vulnerability on another detected vulnerability. For example, it may be the case that multiple functional units are affected by a vulnerability. In turn, this vulnerability can be closed because, for example, a firewall setting was not correct, or the firewall setting is changed by blocking a port. As a result of this measure, the corresponding policy, in particular as a higher-level program, can indicate in turn that this type of change would also be appropriate for the further vulnerability or yet another vulnerability and could therefore be implemented there in the same way. This allows multiple vulnerabilities to be resolved simultaneously by changing the port or configuration. In addition, a so-called patch can correct multiple vulnerabilities and be applicable to multiple components.

In some embodiments, it may be advantageous if the electronic computing device is provided as a central computing device external to the machine. For example, the electronic computing device can then be connected to a network in order to provide appropriate patches. Furthermore, the electronic computing device can be coupled to a plurality of machines, so that appropriate corrective measures on one machine may also be relevant to another machine. Thus, a closed system can be created, wherein on the basis of the electronic computing device, again the investigation of the vulnerabilities can advantageously be carried out.

In some embodiments, the implementation of the corrective action is carried out automatically by means of the electronic computing device. In particular, it may be provided that the proposal for the corrective action is given to the electronic computing device, wherein the electronic computing device in turn also carries out the corrective action automatically according to the proposal. In some embodiments, the proposal is proposed, for example, to a user of the electronic computing device, who can then manually carry out the appropriate corrective action.

In some embodiments, there is a computer program product with program code means, which when the program code means are processed by the electronic computing device, cause said electronic computing device to carry out one or more of the methods described herein. The computer program product may also be referred to as a computer program. Similarly, some embodiments include a computer-readable storage medium having the computer program product.

In some embodiments, the electronic computing device for monitoring a control program of at least one functional unit of a machine installation is designed to carry out a method according to the preceding aspect. In particular, the method is carried out by means of the electronic computing device. The electronic computing device comprises, for example, electronic components, for example processors, circuits, in particular integrated circuits, and further electronic components to be able to carry out corresponding method elements.

Advantages of the method are may be advantages of the computer program product, the computer-readable storage medium, and the electronic computing device. The electronic computing device has in particular concrete features in order to be able to carry out corresponding method elements. For use cases or application situations that may arise in the method and which are not explicitly described here, it may be provided according to the method that an error message and/or a prompt to input user feedback is output and/or a default Setting and/or a predetermined initial state is set. In the figures, identical and functionally equivalent elements are indicated by identical reference signs.

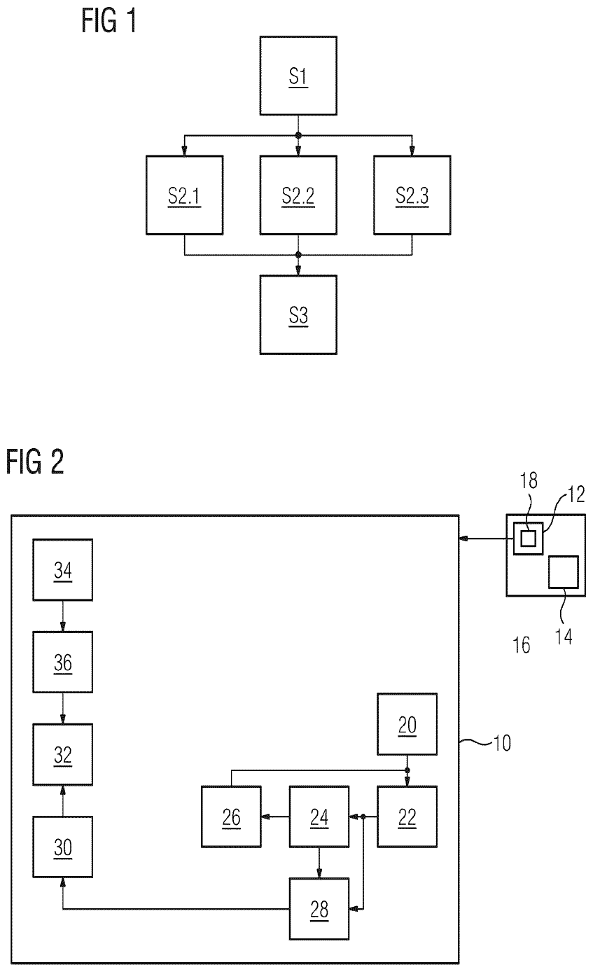

FIG. 1 shows a schematic flowchart of an example method incorporating teachings of the present disclosure. In particular, FIG. 1 shows a method for monitoring a control program 12 (FIG. 2) of at least one functional unit 14 (FIG. 2) of a machine installation 16 (FIG. 2) by means of an electronic computing device 10 (FIG. 2).

In a first step S1 a vulnerability 18 is detected (FIG. 2) within the control program 12. In a second step, S2.1, S2.2, S2.3, the detected vulnerability 18 is categorized on the basis of vulnerabilities that have already been analyzed in the past. In a third step S3, a corrective action for the vulnerability 18 is then proposed depending on the categorization.

In particular, FIG. 1 shows that the vulnerability 18 is categorized into at least two, in particular at least three, categories. In particular, a first category can identify the vulnerability 18 as open, which in the present case is represented by step S2.1. Furthermore, a second category can identify the vulnerability 18 as closed, which in the present case is represented by step S2.2. Furthermore, the vulnerability 18 can be identified as not relevant to the functional unit 14, which in the present is represented by the second step S2.3.

The categorization can be carried out in particular on the basis of a vulnerability characteristic of the vulnerability 18. In particular, a type and/or a manufacturer of the relevant functional unit 14 and/or a location of the relevant functional unit 14 can be described by means of the vulnerability characteristic. For example, an update of the control program 12 can be proposed as the corrective action.

In some embodiments, within the categorization, the vulnerability 18 is compared with other vulnerabilities and, if the vulnerability 18 is similar to at least one other closed vulnerability, the corrective action of the further, already closed, vulnerability 18 is proposed for the vulnerability.

In some embodiments, the categorized vulnerability 18 is analyzed and taken into account for the detection and/or categorization and/or correction of a future vulnerability. Furthermore, an effect of the correction for the vulnerability 18 on further detected vulnerabilities can be checked.

FIG. 2 shows a schematic block diagram of an example electronic computing device 10 incorporating teachings of the present disclosure. FIG. 2 shows in particular that in a block 20, new vulnerabilities, for example the vulnerability 18, are assigned to the functional unit 14. In a block 22, the status or category of the vulnerability 18 is evaluated by a machine learning algorithm, in particular an artificial intelligence system, for example as a neural network. It is then evaluated whether the vulnerability 18 is open. If this is the case, a user will close the vulnerability 18 in block 24. In block 26, the machine learning algorithm then makes the proposal to assign this to similar components, in particular based on so-called tags. In block 28, based on the output of block 22 or block 24 it is decided that the vulnerability 18 is closed. In block 30, corresponding tags can then be added based on identical changes. In block 32, the tags for components or functional units 14 can be supplemented on the basis of the machine learning algorithm. If, for example, new components or functional units 14 are added, this is carried out in this case in block 34. The corresponding tags for the new functional unit 14 can then be added again in block 36.

FIG. 2 thus shows a sequence of a so-called security/ vulnerability use case, which in FIG. 2 is proposed based on a tool. The corresponding functional units 14 are imported, for example, into the Industrial Security Vulnerability Manager (IVM), which means in particular the tool for software identification, monitoring and update provision for security concerns, and in this case is illustrated by the electronic computing device 10. A precondition for this is that the corresponding tags are supplemented, the information being provided automatically in order to increase user-friendliness. The tags are assigned statically, for example, according to the functional unit, the installation part, the IP network or the configuration. All information that is known is used.

A user can also insert their own tags or attributes. These can be derived, for example, from the project planning of an automation system, for example by designating automation components, for example a machine or a machine type, an automation cell, an automation zone, a production, line, a location or these are assigned. It is also possible to take into account current operating data, for example a current operating mode of a machine, state data of the physical, technical system. Additional tags can also be assigned. For this purpose, a machine learning algorithm, in particular AI-based, is also possible as software support to provide additional performance in order to increase the scope of the assignment. In addition to the criteria to be checked, the machine learning algorithm checks how similar cases have been handled in the past, or it acts here to reduce the effort involved. The tags or attributes must be evaluated, clustered and proposals indicated, which constitutes an improvement. A precondition is that all vulnerabilities 18 of this type can be found and modified by the electronic computing device 10. Based on these changes, the machine learning algorithm continues to learn and makes proposals for further changes.

In this case, tags refer to properties of a component or a vulnerability 18 that can be assigned manually or automatically and are machine-readable. They can thus be further processed and compared by a program or a machine learning algorithm, such as an artificial intelligence system. Examples of these include hardware/firmware/software version, IP address, network domain, open ports, physical location, association to a specific installation part/production line, group within which vulnerabilities have been treated in the same way in the past, etc. A component or functional unit 14 can have any number of tags.

What is claimed is:

1. A method for monitoring a control program of a functional unit of a machine installation using an electronic computing device, the method comprising:
detecting a vulnerability within the control program;
categorizing the detected vulnerability on the basis of vulnerabilities already analyzed in the past; and
proposing a corrective action for the vulnerability depending on the categorization.

2. The method as claimed in claim 1, wherein the vulnerability is categorized into at least two categories.

3. The method as claimed in claim 2, wherein:
a first category identifies the vulnerability as open;
a second category identifies the vulnerability as closed; and
a third category identifies the vulnerability as relevant to the functional unit.

4. The method as claimed in claim 1, wherein the categorization is carried out on the basis of a characteristic of the vulnerability.

5. The method as claimed in claim 4, wherein the characteristic corresponds to a type and/or a manufacturer of the relevant functional unit and/or a location of the relevant functional unit.

6. The method as claimed in claim 1, wherein the proposed corrective action includes an update of the control program.

7. The method as claimed in claim 1, wherein categorizing the vulnerability includes comparing the vulnerability with closed vulnerabilities and, if the vulnerability is similar to at least one other closed vulnerability, the corrective action of the closed vulnerability is proposed for the vulnerability.

8. The method as claimed in claim 1, wherein detection of the vulnerability and/or the categorization of the vulnerability and/or the proposal of the corrective action is/are carried out by means of a machine learning algorithm of the electronic computing device.

9. The method as claimed in claim 1, further comprising analyzing the categorized vulnerability and using the result of the analysis for the detection and/or categorization and/or correction of a future vulnerability.

10. The method as claimed in claim 1, further comprising investigating an effect of the correction for the vulnerability on another detected vulnerability.

11. The method as claimed in claim 1, wherein the electronic computing device comprises a central electronic computing device external to the machine.

12. The method as claimed in claim 1, wherein the implementation of the corrective action is carried out automatically using the electronic computing device.

13-15. (canceled)
